(19) United States
(12) Patent Application Publication
(10) Pub. No.: US 2019/0244073 A1
(43) Pub. Date: Aug. 8, 2019

(54) IDENTIFICATION SYSTEMS AND METHODS OF USING IDENTIFICATION SYSTEMS

(71) Applicant: COMPUTYPE, INC., Saint Paul, MN (US)

(72) Inventors: Mike SANISLO, Woodbury, MN (US); Curtis Brian HAUSE, North Lake Elmo, MN (US)

(21) Appl. No.: 15/890,025

(22) Filed: Feb. 6, 2018

(51) Int. Cl. G06K 19/077; H01Q 1/22; H04W 4/80

(52) U.S. Cl. CPC G06K 19/07764; G06K 19/07773; G06K 2017/0045; H04W 4/80; H01Q 1/2241

(57) ABSTRACT

An identification system generally includes at least one identification label that is configured to couple to a first location on a product. The identification label includes a representation of data that is used to describe at least one parameter of the product. A substrate is configured to couple to a second location on the product, wherein the second location is different than the first location. An identification apparatus is configured to couple to the substrate and couples to the second location via the substrate. A computing device is configured to communicatively couple to both the identification label and the identification apparatus. The computing device is also configured to obtain the data from the identification label and transmit the data to the identification apparatus such that a user can later obtain the representation of data from the identification apparatus.

### BACKGROUND

In at least some known industries, providing information about a manufactured product, such as a tire, can be useful for tracking the product as it moves through the manufacturing process, as well as making the manufacturing process more efficient. In addition, information about the product may be added for different purposes following manufacturing. For example, additional information required for distribution, logistics, shipping, wholesale tracking, and retail inventory control and servicing over the life of the product by consumers are all examples where additional information may be needed for product identification and tracking. At least some known systems and methods can be used for tracking products. For example, a bar code label (e.g., a pattern of parallel lines as well as numeric values) can be used for tracking products and/or specialized radio frequency (RF) transponders can be used for tracking products.

At least some known bar code labels can correspond to a unique identification (ID) of the product and/or be representative of other information about the product. Such bar code labels are also operable in the harsh environments encountered during manufacturing. However, information can be written to a bar code label only once, and, thus, bar code labels are limited to storing whatever information is available at the beginning of the manufacturing process when the bar code label is applied. Usually, the amount of information stored on the manufacturer's product is available at the beginning of the manufacturing process, is limited to the unique ID of the product, and is used primarily in the manufacturing process. Additional information linked to the unique ID is stored in an external database and is typically only used in the manufacturing plant.

At least some known specialized radio frequency (RF) transponders are designed to be immune to such harsh environments and enable information to be written multiple times. One example of such a specialized transponder is a spring tag transponder, which uses two conductive, helical coil springs as an antenna for transmitting and receiving information. However, such specialized RF transponders have high costs associated with them, and are, therefore, not economically feasible for use in large-scale manufacturing operations with products aimed at mass consumer markets.

### SUMMARY OF THE INVENTION

The embodiments described herein provide systems and methods for tracking products, such as tires, through the manufacturing process that can withstand relatively high temperatures and pressures and exposure to a variety of chemicals and the tracking can be cost effective. For example, in some embodiments, an identification system is provided for associating a unique identification (ID) and other information with a product, such as a tire, as it moves through a manufacturing process. The identification system generally includes at least one identification label that is configured to couple to a first location on a product. The identification label includes a representation of data that is used to describe at least one parameter of the product. A substrate is configured to couple to a second location on the product, wherein the second location is different than the first location. An identification apparatus is configured to couple to the substrate and couples to the second location via the substrate. A computing device is configured to communicatively couple to both the identification label and the identification apparatus. The computing device is also configured to obtain the data from the identification label and transmit the data to the identification apparatus such that a user can later obtain the data from the identification apparatus.

In other embodiments, a method of using an identification system is disclosed. The method includes coupling an identification label to a first location on a product, wherein the identification label includes a representation of data that is used to describe at least one parameter of the product. A substrate is coupled to an identification apparatus. The identification apparatus, along with the substrate, are coupled to a second location on the product, wherein the second location is different than the first location. A computing device is communicatively coupled to each of the identification label and the identification apparatus. The computing device obtains the data from the identification label and transmits the data to the identification apparatus such that a user can later obtain the data from the identification apparatus.

In still other embodiments, an identification system is disclosed. The identification system generally includes a product, such as a tire, wherein the product includes a first location and a second location that is different than the first location. At least one identification label is configured to couple to the first location of the product, wherein the identification label includes a representation of data that is used to describe at least one parameter of the product. A substrate is configured to couple to the second location of the product. An identification apparatus is configured to couple to the substrate, and couples to the second location via the substrate. A computing device is configured to communicatively couple to each of the identification label and the identification apparatus. The computing device is also configured to obtain the data from the identification label and transmit the data to the identification apparatus such that a user can later obtain the data from the identification apparatus.

### BRIEF DESCRIPTION OF THE DRAWINGS

FIG. 1A illustrates an exemplary block diagram of an exemplary identification system in accordance with some embodiments of the present disclosure.

FIG. 1B illustrates an exemplary identification label that can be used with the system shown in FIG. 1A in accordance with some embodiments of the present disclosure.

FIG. 1C illustrates a top view of an exemplary product taken from area 1 shown in FIG. 1A in accordance with some embodiments of the present disclosure.

FIG. 1D illustrates an exemplary identification apparatus that can be used with the system shown in FIG. 1A in accordance with some embodiments of the present disclosure.

FIG. 2A illustrates an exemplary block diagram of an exemplary computing device that can be used with the system shown in FIG. 1A in accordance with some embodiments of the present disclosure.

FIG. 2B illustrates an exemplary block diagram of exemplary software modules that can be used with the computing device shown in FIG. 2A in accordance with some embodiments of the present disclosure.

FIG. 3 illustrates an exemplary flow diagram of an exemplary method for using the identification system shown in FIG. 1A.

### DETAILED DESCRIPTION

The embodiments described herein enable the cost-effective association of a unique identification (ID) and other information with a product, such as a tire, as it moves through a manufacturing process, and/or any subsequent processes (e.g. shipping). At least one identification label having a unique ID stored thereon is coupled to a first location of the product. An identification apparatus is coupled to a second location of the product via a substrate, wherein the second location is different from the first location. The unique ID may be read from the identification label and stored in the identification apparatus along with other information about the product. The second location of the product may be on an inner surface of the product. As information from subsequent stages of the manufacturing process is generated, such information may also be stored in the identification apparatus.

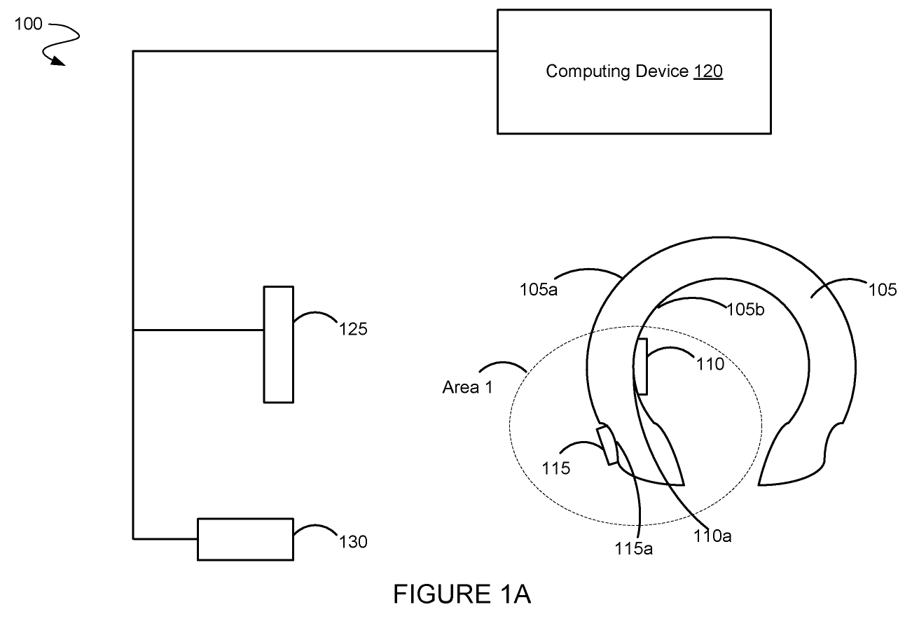

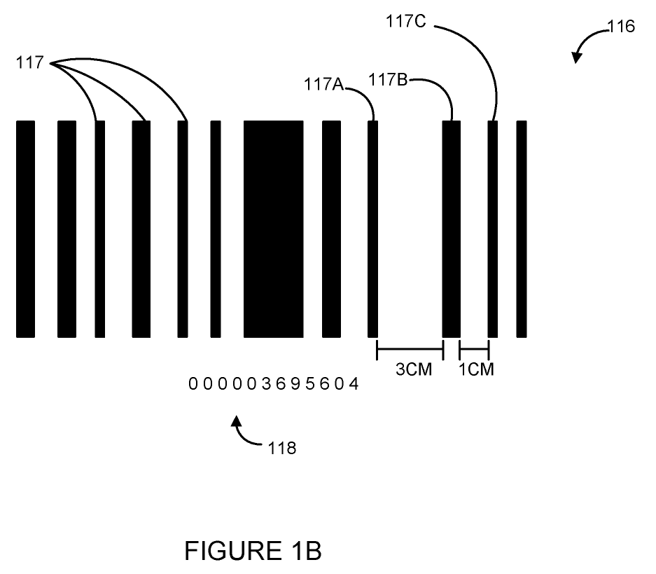

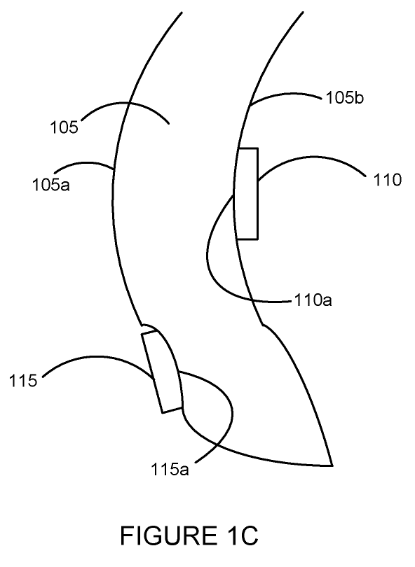

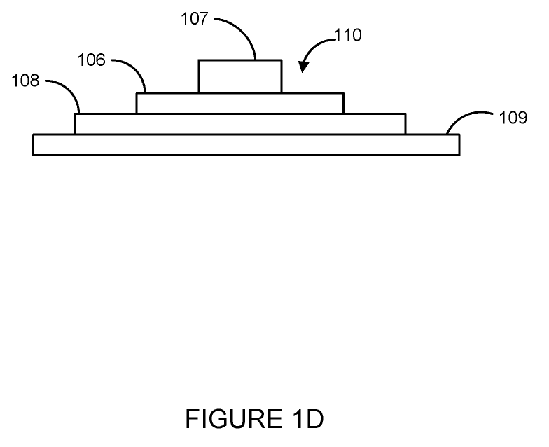

FIG. 1A illustrates a system 100 for associating a unique identification (ID) and other information with a product during a manufacturing process. System 100 may include a product 105 that can be used by, for example, consumers. As shown in FIG. 1, product 105 can be a tire 105. While tire 105 is illustrated, one of ordinary skill in the art will appreciate that the present disclosure may be used in connection with other systems that are used to track and identify various types of products during a manufacturing process and other processes that may occur over the life of the product (e.g. shipping). For example, in some embodiments, system 100 can be a blood collection system that is used to collect blood and store the blood in blood storage bags (not shown) having identification labels representing various parameters (e.g. donor name, donor blood type). System 100 also includes an identification apparatus 110, at least one identification label, such as identification label 115, a computing device 120, a radio frequency identification (RFID) read/write (R/W) device 125, and a bar code reader 130.

Identification label 115 may be, for example, any suitable bar code label having a bar code representing a unique ID. The unique ID may be any alpha-numeric character sequence suitable for identifying a product, such as tire 105. FIG. 1B illustrates a bar code 116 that can be used as identification label 115 (shown in FIG. 1A) in accordance with some embodiments of the present disclosure. Bar code 116 may include a machine-readable pattern of unequally spaced parallel lines 117 as well as alpha-numeric values 118 that represent the unique ID. For example, as shown in FIG. 1B, the distance between adjacent parallel lines 117a and 117b (3 centimeters) may be different than the distance between adjacent parallel lines 117b and 117c (1 centimeter). For example, each parallel line can be spaced a distance X from an adjacent parallel line. The numeric values can be positioned under the parallel lines.

Referring back to FIG. 1A, identification label 115 may be coupled to tire 105. In some embodiments, identification label 115 may be coupled to an external surface 105a of tire 105 at a first location 115a using any suitable heat and pressure resistant adhesives and primers known to one of ordinary skill in the art.

Identification apparatus 110 may also be coupled to tire 105 at a second location 110a, wherein second location 110a is different than the first location 115a where identification label 115 is coupled to tire 105. In some embodiments, identification apparatus 110 may be coupled to an inner surface 105b of tire 105 as shown in FIG. 1A, and may be configured to receive, store, and transmit information about tire 105, such as the unique ID.

In some embodiments, identification apparatus 110 may be a known radio frequency (RF) transponder that is not adapted for harsh manufacturing environments (unlike a spring tag transponder). Identification apparatus 110 may be coupled to the tire 105 via a substrate (shown in FIG. 1D) that is resistant to high temperatures. During manufacture, the rubber of tire 105 may be heated to high temperatures that can damage identification apparatus 110. By being coupled to inner surface 105b of tire 105 via the heat resistant substrate, identification apparatus 110 may only be exposed to rubber on the side that is coupled to (and thus protected by) the heat resistant substrate. In this way, the extent to which identification apparatus 110 is exposed to heated rubber during a post-vulcanization manufacturing process, for example, is decreased and the life of identification apparatus 110 is increased. It should be noted that, as used herein, the term “couple” is not limited to a direct mechanical, communicative, and/or an electrical connection between components, but may also include an indirect mechanical, communicative, and/or electrical connection, including a wireless radio frequency connection between two or more components or a coupling that is operative through intermediate elements or spaces.

FIG. 1C illustrates a sectional view of tire 105 taken from Area 1 (shown in FIG. 1A) where the identification apparatus 110 and the identification label 115 are coupled to tire 105. As shown, identification label 115 may be coupled to the tire 105 at a first location 115a and identification apparatus 110 may be coupled to tire 105 at a second location 110a. In some embodiments, identification apparatus 110 may be coupled to inner surface 105b of tire 105, while identification label 115 may be coupled to an external surface 105a of tire 105 as shown in FIG. 1C. In some embodiments, various parameters of identification apparatus 110 may be determined based on a finite elements analysis (FEA) model of tire 105. For example, the second location 110a where identification apparatus 110 may be coupled to tire 105 may be determined based on an FEA model of tire 105.

Referring back to FIG. 1A, bar code reader 130 may be coupled to computing device 120 and identification label 115, and may be configured to scan a bar code and extract information therefrom. Bar code reader 130 may be any suitable camera or laser based scanner. RFID R/W device 125 may be coupled to computing device 120 and identification apparatus 110 and may be any device suitable for reading information from and/or writing information to identification apparatus 110.

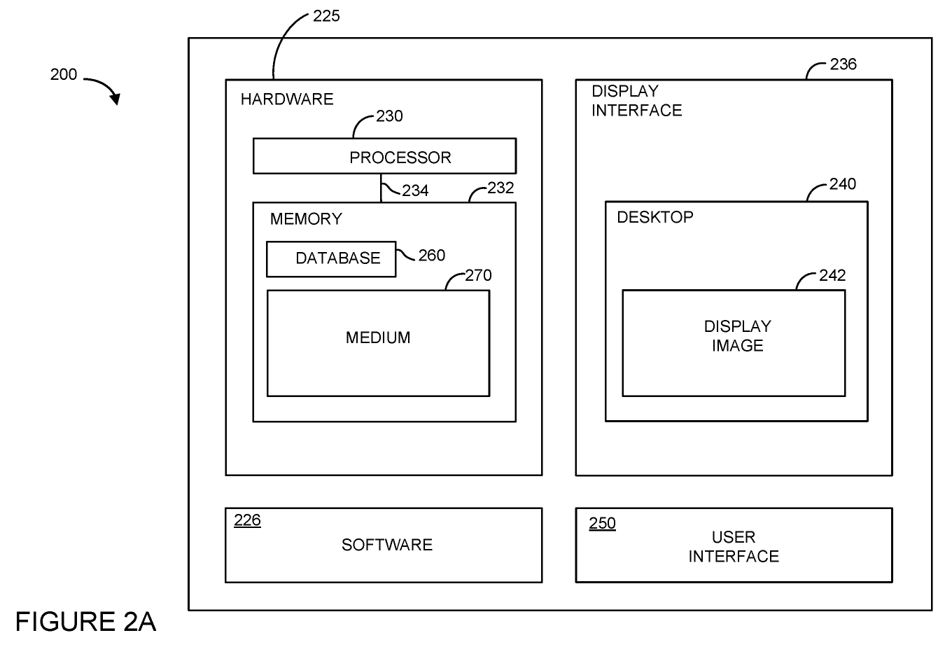

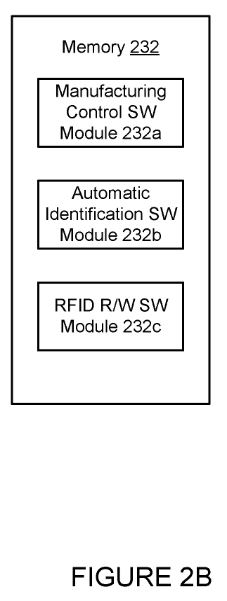

Computing device 120 may be, for example, a server, desktop computer, laptop, mobile device, tablet, thin client, or other device having a communications interface (not shown) that can communicate with other components of system 100, as explained in more detail below with respect to FIG. 2A. In some embodiments, computing device 120 may be associated with, for example, a tire manufacturing plant. Computing device 120 may be responsible for initiating each of the various stages of a manufacturing process, and communicating with the identification label 115 and the identification apparatus 110. More specifically, computing device may associate information related to each stage of the manufacturing process as well as information obtained from identification label 115 with identification apparatus 110 as discussed in further detail below.

During operation, as explained in more detail below with respect to FIGS. 1A, 1D, 2A, 2B, and 3, system 100 can be used to facilitate associating a unique identification (ID) and other information with tire 105 during a manufacturing process.

FIG. 1D illustrates the identification apparatus 110 of FIG. 1A coupled to a heat resistant substrate in accordance with some embodiments of the present disclosure. Identification apparatus 110 may include antenna 106 and integrated circuit (IC) 107. Antenna 106 may be made from any suitable material. In some embodiments, antenna 106 may be a flat, etched, copper or aluminum antenna. Antenna 106 may be configured to receive and transmit information about tire 105, such as the unique ID for example while mounted on the inner liner of the tire. The IC 107 may include a processor and memory (not shown). The processor of IC 107 may function to receive information from antenna 106 and store received information in the memory of IC 107. The memory of IC 107 may also store data for apparatus 110, which can be used to identify identification apparatus 110 when information from identification apparatus 110 is sought by a user, for example. In addition, in response to receiving a request for information via antenna 106, the processor may retrieve the requested information from the memory of IC 107 and relay it to the requesting party (e.g. RFID R/W device 125) as is known in the art.

Identification apparatus 110 may be coupled to a substrate 108. Substrate 108 may be made from any suitable material that is resistant to high temperatures. For example, substrate 108 may be a polyimide substrate. Substrate 108 (and thus, identification apparatus 110) may be coupled to coupling layer 109, which is configured to couple the substrate 108 (and thus, identification apparatus 110) to tire 105 (shown in FIG. 1A). The coupling layer 109 may be an energy absorbing carrier having an adhesive that enables the substrate 108 to be coupled to an inner surface 105b of tire 105.

FIG. 2A is a block diagram of an exemplary computing device 200, which may be used to implement computing device 120 (shown in FIG. 1A). In some embodiments, computing device 200 includes a hardware unit 225 and software 226. Software 226 can run on hardware unit 225 such that various applications or programs can be executed on hardware unit 225 by way of software 226. In some embodiments, the functions of software 226 can be implemented directly in hardware unit 225, e.g., as a system-on-a-chip, firmware, field-programmable gate array (“FPGA”), etc. In some embodiments, hardware unit 225 includes one or more processors, such as processor 230. In some embodiments, processor 230 is an execution unit, or “core,” on a microprocessor chip. In some embodiments, processor 230 may include a processing unit, such as, without limitation, an integrated circuit (“IC”), an ASIC, a microcomputer, a programmable logic controller (“PLC”), and/or any other programmable circuit. Alternatively, processor 230 may include multiple processing units (e.g., in a multi-core configuration). The above examples are exemplary only, and, thus, are not intended to limit in any way the definition and/or meaning of the term “processor.”

Hardware unit 225 also includes a system memory 232 that is coupled to processor 230 via a system bus 234. Memory 232 can be a general volatile RAM. For example, hardware unit 225 can include a 32 bit microcomputer with 2 Mbit ROM and 64 Kbit RAM, and/or a few GB of RAM. Memory 232 can also be a ROM, a network interface (MC), and/or other device(s).

In some embodiments, computing device 200 can also include at least one media output component or display interface 236 for use in presenting information to a user. Display interface 236 can be any component capable of conveying information to a user and may include, without limitation, a display device (not shown) (e.g., a liquid crystal display (“LCD”), an organic light emitting diode (“OLED”) display, or an audio output device (e.g., a speaker or headphones)). In some embodiments, computing device 300 can output at least one desktop, such as desktop 240. Desktop 240 can be an interactive user environment provided by an operating system and/or applications running within computing device 200, and can include at least one screen or display image, such as display image 242. Desktop 240 can also accept input from a user in the form of device inputs, such as keyboard and mouse inputs. In some embodiments, desktop 240 can also accept simulated inputs, such as simulated keyboard and mouse inputs. In addition to user input and/or output, desktop 240 can send and receive device data, such as input and/or output for a FLASH memory device local to the user, or to a local printer.

In some embodiments, display image 242 can be presented to a user on computer displays of a remote terminal (not shown). For example, computing device 200 can be connected to one or more remote terminals (not shown) or servers (not shown) via a network (not shown), wherein the network can be the Internet, a local area network (“LAN”), a wide area network (“WAN”), a personal area network (“PAN”), or any combination thereof, and the network can transmit information between computing device 300 and the remote terminals or the servers, such that remote end users can access the information from computing device 200.

In some embodiments, computing device 200 includes an input or a user interface 250 for receiving input from a user. User interface 250 may include, for example, a keyboard, a pointing device, a mouse, a stylus, a touch sensitive panel (e.g., a touch pad or a touch screen), a gyroscope, an accelerometer, a position detector, and/or an audio input device. A single component, such as a touch screen, may function as both an output device of the media output component and the input interface. In some embodiments, mobile devices, such as tablets, can be used.

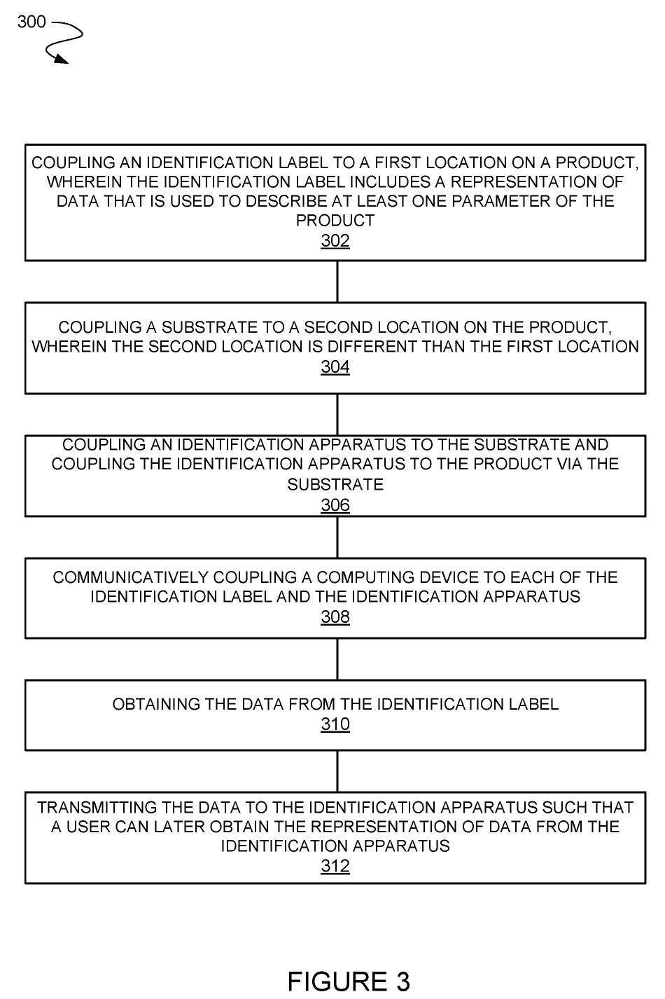

Computing device 200, in some embodiments, can include a database 260 within memory 232, such that various information can be stored within database 260. Alternatively, in some embodiments, database 260 can be included within a remote server (not shown) with file sharing capabilities, such that database 260 can be accessed by computing device 200 and/or remote end users. In some embodiments, a plurality of computer-executable instructions can be stored in memory 232, such as one or more computer-readable storage media 270 (only one being shown in FIG. 2A). Computer storage medium 270 includes non-transitory media and may include volatile and nonvolatile, removable and non-removable mediums implemented in any method or technology for storage of information such as computer-readable instructions, data structures, program modules or other data. The instructions may be executed by processor 230 to perform various functions described herein, e.g., steps of the process shown in FIG. 3.

FIG. 2B illustrates memory 232 (shown in FIG. 2A) and the various software (SW) modules that may be stored therein. Memory 232 may comprise a non-transitory computer-readable medium (e.g., one or more nonvolatile memory elements, such as EPROM, EEPROM, Flash memory, a hard drive, and so on) that may store at least the following software (SW) modules: (1) a manufacturing control SW module 232a to initiate each stage of the manufacturing process; (2) an automatic identification SW module 232b to enable communication with bar code reader 130 as discussed herein; and (3) a RFID R/W SW module 232c to enable communication with RFID R/W device 125 as discussed herein.

Referring back to FIG. 1A, in some embodiments, identification apparatus 110 may be coupled to tire 105 after execution of one or more stages of the manufacturing process that may potentially damage a standard RF transponder, such as vulcanization of tire 105.

Upon coupling of the identification apparatus 110 to the second location 110a, computing device 120 may obtain the unique ID from identification label 115. More specifically, computing device 120 may transmit instructions to bar code reader 130 to scan the bar code on identification label 115 and extract the unique ID from the bar code. Bar code reader 130 may transmit the unique ID and/or other information to computing device 120.

Computing device 120 may associate the unique ID with the identification apparatus 110. More specifically, computing device 120 may associate the unique ID with the RFID of identification apparatus 110 and store the association in memory (shown in FIG. 2A). Computing device 120 may transmit the unique ID to the RFID R/W device 125, along with instructions for the RFID R/W device 125 to write the unique ID to identification apparatus 110 as discussed above.

In some embodiments, computing device 120 may also transmit other information related to the vulcanization process to RFID R/W device 125 to be written to the identification apparatus 110. For example, computing device 120 may transmit the employee ID of the technician responsible for checking the vulcanization process, the time and date the vulcanization process was carried out, the production line ID, and the mold ID of the mold in which the tire 105 was vulcanized, or other indicators of process quality, for example.

As the tire 105 moves through the manufacturing process, computing device 120 may continually transmit information relevant to each stage of the process to RFID R/W device 125 to be written to Identification apparatus 110. For example, computing device 120 may initiate a stage of the manufacturing process wherein tire 105 is given a chemical coating. Upon completion of the coating, computing device 120 may transmit to RFID R/W device 125, the chemical composition of the coating, the ID of the employee/technician tasked with ensuring the coating was properly applied, and the time/date the coating was applied among other information. RFID R/W device 125 may write this information to identification apparatus 110. In some embodiments, an additional identification label (not shown) containing the above mentioned information about the chemical coating may be applied to tire 105 upon completion of the coating. Computing device 120 may retrieve the information from the additional identification label as discussed above, and associate the information with identification apparatus 110 as discussed above. Computing device 120 may associate data from any number of additional identification labels applied to tire 105 in this manner.

In some embodiments, bar code reader 130 may continuously search for identification labels and in response to detecting an identification label, automatically scan the identification label's bar code and extract the unique ID and/or other information from the scanned bar code. Bar code reader 130 may then transmit the extracted unique ID and/or other information to computing device 120.

In some embodiments, identification apparatus 110 may receive information from additional identification labels (not shown) applied to tire 105 as part of an entirely different system. For example, prior to being shipped to a store, an identification label storing the carrier information, destination, and date/time of shipping may be applied by the carrier to tire 105. The carrier system (not shown) may contain a computing device similar to computing device 120 that may associate information from the additional identification labels applied during the shipping process with identification apparatus 110.

FIG. 3 illustrates a flow diagram of a method for using an identification system in accordance with some embodiments of the present disclosure. The method may be performed by system 100 of FIG. 1A, for example.

Tire 105 may begin the manufacturing process as uncured rubber that has not yet been vulcanized in a mold, for example. At 302, identification label 115 may be coupled to a first location 115a on the external surface 105a of tire 105. In some embodiments, computing device 120 may initiate a vulcanization process, causing tire 105 to be inserted into a mold (not shown) where it may be exposed to high temperatures and high pressure so as to take on the desired form. The high temperatures and high pressure involved in the vulcanization process may potentially damage a standard RF transponder.

At 304, substrate 108 (shown in FIG. 1D) may be coupled to tire 105 at a second location 110a that is different from the first location 115a where the identification label 115 is coupled. At 306, identification apparatus 110 may be coupled via substrate 108 to tire 105. In some embodiments, identification apparatus 110 may be coupled (via substrate 108) to an inner surface 105b of tire 105 as shown in FIG. 1A, thereby decreasing the extent to which identification apparatus 110 is exposed to rubber during subsequent manufacturing processes, as discussed above.

At 308, computing device 120 may communicatively couple to each of the identification apparatus 110 and the identification label 115 in order to obtain the unique ID from identification label 115 and associate the unique ID with identification apparatus 110. More specifically, at 310, computing device 120 may transmit instructions to bar code reader 130 to scan the bar code on identification label 115 and extract the unique ID from the bar code. Bar code reader 130 may transmit the unique ID to computing device 120.

At 312, computing device 120 may associate the unique ID with the identification apparatus 110. More specifically, computing device 120 may transmit the unique ID to the RFID R/W device 125, along with instructions for the RFID R/W device 125 to write the unique ID to identification apparatus 110. In some embodiments, computing device 120 may also transmit other information related to the vulcanization process to RFID R/W device 125 to be written to the identification apparatus 110. For example, computing device 120 may transmit the employee ID of the technician responsible for checking the vulcanization process, the time and date the vulcanization process was carried out, the production line ID, and the mold ID of the mold in which the tire 105 was vulcanized, for example.

As the tire 105 moves through the manufacturing process, computing device 120 may continually transmit information relevant to each stage of the process to RFID R/W device 125 to be written to Identification apparatus 110. For example, computing device 120 may initiate a stage of the manufacturing process wherein tire 105 is given a chemical coating. Upon completion of the coating, computing device 120 may transmit to RFID R/W device 125, the chemical composition of the coating, the ID of the employee/technician tasked with ensuring the coating was properly applied, and the time/date the coating was applied among other information. RFID R/W device 125 may write this information to identification apparatus 110. In some embodiments, an additional identification label (not shown) containing the above mentioned information about the chemical coating may be applied to tire 105 upon completion of the coating. Computing device 120 may retrieve the information from the additional identification label as discussed above, and associate the information with identification apparatus 110 as discussed above. Computing device 120 may associate data from any number of additional identification labels applied to tire 105 in this manner.

In some embodiments, bar code reader 130 may continuously search for identification labels and in response to detecting an identification label, automatically scan the identification label's bar code and extract the unique ID and/or other information from the scanned bar code. Bar code reader 130 may then transmit the extracted unique ID and/or other information to computing device 120.

In some embodiments, identification apparatus 110 may receive information from additional identification labels (not shown) applied to tire 105 as part of an entirely different system. For example, prior to being shipped to a store, an identification label storing the carrier information, destination, and date/time of shipping may be applied by the carrier to tire 105. The carrier system (not shown) may contain a computing device similar to computing device 120 that may associate information from the additional identification labels applied during the shipping process with identification apparatus 110.

Exemplary embodiments of the systems and methods are described above in detail. The systems and methods are not limited to the specific embodiments described herein, but rather, components of the systems and/or steps of the method may be utilized independently and separately from other components and/or steps described herein. For example, the system may also be used in combination with other systems and methods, and is not limited to practice with only a system as described herein. Rather, the exemplary embodiment can be implemented and utilized in connection with many other systems.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

While the embodiments have been described and/or illustrated by means of particular examples, and while these embodiments and/or examples have been described in considerable detail, it is not the intention of the Applicants to restrict or in any way limit the scope of the embodiments to such detail. Additional adaptations and/or modifications of the embodiments may readily appear, and, in its broader aspects, the embodiments may encompass these adaptations and/or modifications. Accordingly, departures may be made from the foregoing embodiments and/or examples without departing from the scope of the concepts described herein. The implementations described above and other implementations are within the scope of the following claims.

What is claimed is:

1. An identification system comprising:
at least one identification label that is configured to couple to a first location on a product, wherein said at least one identification label comprises a representation of data that is used to describe at least one parameter of the product;
a substrate configured to couple to a second location on the product, wherein the second location is different than the first location;
an identification apparatus configured to couple to said substrate and configured to couple to the second location via said substrate; and
a computing device configured to communicatively couple to each of said at least one identification label and said identification apparatus, wherein said computing device is further configured to:
obtain the data from said at least one identification label; and
transmit the data to said identification apparatus such that a user can later obtain the data from said identification apparatus.

2. The identification system of claim 1, wherein the representation of data comprises a machine-readable code in the form of alpha-numeric values and at least one pattern of parallel lines.

3. The identification system of claim 2, wherein said identification apparatus comprises a radio frequency (RF) transponder comprising a radio frequency identification (RFID) and the second location is on an inner surface of the product.

4. The identification system of claim 3, further comprising:
a bar code reader configured to couple to said computing device and said at least one identification label and further configured to scan the alpha-numeric values and the at least one pattern of parallel lines and extract the data from the alpha-numeric values and the at least one pattern of parallel lines; and
a RFID read/write (R/W) device configured to couple to said computing device and said identification apparatus and further configured to write information to and read information from said identification apparatus.

5. The identification system of claim 4, wherein to obtain the data from said at least one identification label, said computing device is configured to:
receive the data from said bar code reader upon said bar code reader's extraction of the data from the alpha-numeric values and the at least one pattern of parallel lines.

6. The identification system of claim 4, wherein to transmit the data to said identification apparatus, said computing device is configured to:
transmit the data to said RFID R/W device; and
transmit a signal instructing said RFID R/W device to write the data to said identification apparatus.

7. The identification system of claim 1, wherein said substrate comprises a polyimide substrate.

8. A method of using an identification system, the method comprising:
coupling an identification label to a first location on a product, wherein the identification label includes a representation of data that is used to describe at least one parameter of the product;
coupling a substrate to an identification apparatus;
coupling the identification apparatus, along with the substrate, to a second location on the product, wherein the second location is different than the first location;
communicatively coupling a computing device to each of the at least one identification label and the identification apparatus;
obtaining the data from the at least one identification label; and
transmitting the data to the identification apparatus such that a user can later obtain the data from the identification apparatus.

9. The method of claim 8, wherein the representation of data includes a machine-readable code in the form of alpha-numeric values and at least one pattern of parallel lines.

10. The method of claim 8, wherein the identification apparatus includes a radio frequency (RF) transponder comprising a radio frequency identification (RFID) and the second location is on an inner surface of the product.

11. The method of claim 9, wherein said obtaining the data from the identification label comprises:
extracting, using a bar code reader, the data from the alpha-numeric values and the at least one pattern of parallel lines; and
receiving, from the bar code reader, the data.

12. The method of claim 10, wherein said transmitting the data to the identification apparatus comprises:
transmitting the data to a RFID read/write (R/W) device; and
transmitting a signal instructing the RFID R/W device to write the data to the RF transponder.

13. The method of claim 8, further comprising:
receiving, at the identification apparatus, additional data corresponding to at least one additional identification label; and
storing the additional data in the identification apparatus such that the user can later obtain the additional data from the identification apparatus.

14. An identification system comprising:
a product comprising a first location and a second location that is different than said first location;
at least one identification label that is configured to couple to said first location of said product, wherein said at least one identification label comprises a representation of data that is used to describe at least one parameter of said product;
a substrate configured to couple to said second location of said product;
an identification apparatus configured to couple to said substrate and configured to couple to said second location via said substrate; and
a computing device configured to communicatively couple to each of said at least one identification label and said identification apparatus, wherein said computing device is further configured to:
obtain the data from said at least one identification label; and
transmit the data to said identification apparatus such that a user can later obtain the data from said identification apparatus.

15. The identification system of claim 14, wherein the representation of data comprises a machine-readable code in the form of alpha-numeric values and at least one pattern of parallel lines.

16. The identification system of claim 15, wherein said identification apparatus comprises a radio frequency (RF) transponder comprising a radio frequency identification (RFID) and the second location is on an inner surface of said product.

17. The identification system of claim 16, further comprising:
a bar code reader configured to couple to said computing device and said at least one identification label and further configured to scan the alpha-numeric values and the at least one pattern of parallel lines and extract the data from the alpha-numeric values and the at least one pattern of parallel lines; and
a RFID read/write (R/W) device configured to couple to said computing device and said identification apparatus and further configured to write information to and read information from said identification apparatus.

18. The identification system of claim 17, wherein to obtain the data from said at least one identification label, said computing device is configured to:
receive the data from said bar code reader upon said bar code reader's extraction of the data from the alpha-numeric values and the at least one pattern of parallel lines.

19. The identification system of claim 17, wherein to transmit the data to said identification apparatus, said computing device is configured to:
transmit the data to said RFID R/W device; and
transmit a signal instructing said RFID R/W device to write the data to said identification apparatus.

20. The identification system of claim 14, wherein said substrate comprises a polyimide substrate.
